(19) United States
(12) Patent Application Publication
(10) Pub. No.: US 2025/0100553 A1
(43) Pub. Date: Mar. 27, 2025

(54) System and Method for Reducing Rapid Deceleration of Vehicles

(71) Applicant: GOOGLE LLC, Mountain View, CA (US)

(72) Inventors: Catherine Cardinal, Mountain View, CA (US); Cliff Chin Ngai Sze, Mountain View, CA (US)

(21) Appl. No.: 18/559,520

(22) PCT Filed: Feb. 22, 2023
(86) PCT No.: PCT/US23/63018

§ 371 Date: Nov. 7, 2023

(51) Int. Cl. B60W 30/14; B60W 30/18; B60W 50/14; B60W 60/00; G08G 1/01; G08G 1/052

(52) U.S. Cl. CPC B60W 30/143; B60W 30/18163; B60W 50/14; B60W 60/001; G08G 1/0104; G08G 1/052; B60W 2050/146; B60W 2554/4041; B60W 2554/4046; B60W 2554/802

(57) ABSTRACT

To control a vehicle to reduce traffic on a road segment, a computing device obtains an indication of a location of a vehicle on a road segment traveling to a destination. The computing device identifies a cluster of vehicles including the vehicle on the road segment and respective positions of the vehicles in the cluster. Then the computing device identifies a particular speed or a particular lane for the vehicle which minimizes an estimated time of arrival (ETA) at the destination based on the respective positions of the vehicles in the cluster, and determines a delay in the ETA if the vehicle continues to proceed in its current manner. The computing device provides an indication of the particular speed or the particular lane for the vehicle which minimizes the ETA, and an indication of the delay in the ETA if the vehicle continues to proceed in its current manner.

### FIELD OF THE DISCLOSURE

The present disclosure relates to digital mapping data and, more particularly, to reducing rapid deceleration events for vehicles which can cause traffic jams by providing instructions to users and vehicles entering a road segment.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many users request map and navigation data for various geographic locations. Software applications typically generate navigation data in response to receiving input from a user, specifying the starting point and the destination. Furthermore, many users, particularly in densely populated areas, experience heavy traffic on a daily basis. During these periods, vehicles speed up for a brief moment before coming to a stop and then repeat this process several times before reaching their respective destinations. While large highways and expressways can reduce traffic since they do not have intersections, heavy traffic also occurs on highways and expressways for different reasons, such as accidents, lane closures, construction, etc.

In some scenarios, traffic jams may occur without an accident or lane closure. Oftentimes, drivers sit in traffic for lengthy periods expecting to approach an accident, lane closure, construction area, etc., before being able to speed up and continue on to their destinations without any more delays. However, these drivers are unable to determine the cause of the traffic jam and instead at some point traffic lightens and they begin speeding up without any apparent reason. One cause of such traffic jams is a phenomenon known as the “phantom traffic jam,” in which vehicles slow down or stop without an apparent cause. These “phantom traffic jams” are due to a chain reaction caused by one vehicle slowing down on a densely populated roadway (also referred to herein as a “deceleration event”). This causes the vehicle behind it to slow down even more and sets off a chain reaction of cars slowing down which acts like a traveling wave. By the time each vehicle on the roadway reduces speed and waits for the vehicle in front to speed up, this process may repeat itself. In this manner, one vehicle that slows down too rapidly on a densely populated roadway can create a half hour, an hour, or even hours of traffic. In 2009, scientists at the University of Alberta and Massachusetts Institute of Technology proposed an equation describing this phenomenon, which explains how a temporary disturbance (such as a sudden influx of traffic or vehicles changing lanes) can cause a chain reaction of sudden braking that may that trickle down a road for hours (M. R. Flynn, A. R. Kasimov, J.-C. Nave, R. R. Rosales, and B. Seibold, “Self-sustained nonlinear waves in traffic flow,” Physical Review E, 2009; 79 (5).)

### SUMMARY

To reduce the effects of traffic jams, a deceleration reduction system determines a target speed for a vehicle on a road segment to maintain a proper following distance between the vehicle and a vehicle in front of the vehicle. In some implementations, the proper following distance is such that the distance between the vehicle and the vehicle in front of the vehicle is the same as the distance between the vehicle and the vehicle behind the vehicle. Also in some implementations, the deceleration reduction system may identify a lane for the vehicle based on its current speed to reduce the effects of traffic jams. For example, if the vehicle is traveling below the average speed of vehicles in the left lane but at or near the average speed of vehicles in the right lane, the deceleration reduction system may instruct the vehicle to move into the right lane.

The deceleration reduction system also obtains a set of navigation directions for traveling to a destination and determines an estimated time of arrival (ETA) for arriving at the destination based on current traffic patterns if the vehicle proceeds in its current manner (e.g., by maintaining its current speed, current lane, or current following distance). Additionally, the deceleration reduction system determines an ETA for arriving at the destination if the vehicle travels at the target speed and/or the recommended lane. Then the deceleration reduction system compares the ETA if the vehicle proceeds in the current manner to the ETA if the vehicle travels at the target speed and/or the recommended lane. The deceleration reduction system then provides, to a client device in the vehicle, an indication of the target speed or the recommended lane for the vehicle which minimizes the ETA, and/or an indication of the delay in the ETA if the vehicle proceeds in the current manner. The client device may be a vehicle head unit or may be a client device of a user in the vehicle, such as a smartphone or tablet.

In some implementations, the client device presents the indications of the target speed, the recommended lane, and/or the delay in the ETA on a display, such as a map display of a navigation application. Then the user may adjust the speed of vehicle accordingly or change lanes to prevent a potential delay in the ETA and/or reduce the amount of traffic caused by unnecessary deceleration events on the road segment. As such, the provision of an indication of the target speed or recommended lane, such as presenting on a display as described above, provides the user with a concrete action which would reduce traffic on a road segment. The provided indications thus ensure an objective improvement in the flow of traffic. The provision of an indication of the delay in the ETA provides a user with an updated arrive time based on their current driving speed, lane or following distance, thus providing a more accurate arrival time. In other implementations, the deceleration reduction system provides the indications of the target speed, the recommended lane, and/or the delay in the ETA to a computing device within the vehicle that controls some operation of the vehicle, such as a computing device in an autonomous vehicle, a semi-autonomous vehicle, or any other vehicle having autonomous operation features. In this manner, the computing device may control the vehicle to adjust the speed and travel at the target speed and/or to change lanes to the recommended lane. By automating this action, an objective improvement in the flow of traffic is provided automatically.

In particular, an example embodiment of the techniques of the present disclosure is a method for controlling a vehicle to reduce traffic on a road segment. The method includes obtaining an indication of a location of a vehicle on a road segment traveling to a destination, identifying a cluster of vehicles including the vehicle on the road segment and respective positions of the vehicles in the cluster, and identifying a particular speed or a particular lane for the vehicle which minimizes an estimated time of arrival (ETA) at the destination based on the respective positions of the vehicles in the cluster. The method further includes determining a delay in the ETA if the vehicle proceeds at a current speed, in a current lane, or at a current following distance from a vehicle directly in front of the vehicle, and providing (i) an indication of the particular speed or the particular lane for the vehicle which minimizes the ETA, and (ii) an indication of the delay in the ETA if the vehicle proceeds at the current speed, in the current lane, or at the current following distance.

Another embodiment of these techniques is a computing device for controlling a vehicle to reduce traffic on a road segment. The computing device includes one or more processors and a computer-readable memory, which is optionally non-transitory, storing instructions thereon. When executed by the one or more processors, the instructions cause the computing device to obtain an indication of a location of a vehicle on a road segment traveling to a destination, identify a cluster of vehicles including the vehicle on the road segment and respective positions of the vehicles in the cluster, and identify a particular speed or a particular lane for the vehicle which minimizes an estimated time of arrival (ETA) at the destination based on the respective positions of the vehicles in the cluster. The instructions also cause the computing device to determine a delay in the ETA if the vehicle proceeds at a current speed, in a current lane, or at a current following distance from a vehicle directly in front of the vehicle, and provide (i) an indication of the particular speed or the particular lane for the vehicle which minimizes the ETA, and (ii) an indication of the delay in the ETA if the vehicle proceeds at the current speed, in the current lane, or at the current following distance.

Yet another embodiment of these techniques is a computer-readable memory, which is optionally non-transitory, storing instructions thereon. When executed by the one or more processors, the instructions cause the one or more processors to obtain an indication of a location of a vehicle on a road segment traveling to a destination, identify a cluster of vehicles including the vehicle on the road segment and respective positions of the vehicles in the cluster, and identify a particular speed or a particular lane for the vehicle which minimizes an estimated time of arrival (ETA) at the destination based on the respective positions of the vehicles in the cluster. The instructions also cause the one or more processors to determine a delay in the ETA if the vehicle proceeds at a current speed, in a current lane, or at a current following distance from a vehicle directly in front of the vehicle, and provide (i) an indication of the particular speed or the particular lane for the vehicle which minimizes the ETA, and (ii) an indication of the delay in the ETA if the vehicle proceeds at the current speed, in the current lane, or at the current following distance.

### BRIEF DESCRIPTION OF THE DRAWINGS

FIG. 1A illustrates an example scenario including vehicles on a roadway that create traffic by following too closely together;

FIG. 1B illustrates another example scenario including vehicles on a roadway that do not create traffic by maintaining the appropriate following distances;

FIG. 2 illustrates an example vehicle in which the techniques of the present disclosure can be used to control a vehicle to reduce rapid deceleration events on a road segment;

FIG. 3 is a block diagram of an example communication system in which techniques for reducing rapid deceleration events can be implemented;

FIG. 4 is an example navigation display which may be presented on a user's client device which indicates a target speed for a vehicle to minimize an ETA to the vehicle's destination;

FIG. 5 is another example navigation display which may be presented on a user's client device which indicates a recommended lane for a vehicle to minimize an ETA to the vehicle's destination;

FIG. 6 is yet another example navigation display which may be presented on a user's client device which provides a recommendation not to frequently change lanes;

FIG. 7 is another example navigation display which may be presented on a user's client device which indicates the timing for when to merge to minimize an ETA to the vehicle's destination;

FIG. 8 is a flow diagram of an example method for determining an expected traffic slowdown for a cluster of vehicles on a road segment using machine learning models; and

FIG. 9 is a flow diagram of an example method for controlling a vehicle to reduce traffic on a road segment, which may be implemented in a server device.

### DETAILED DESCRIPTION

### Overview

The present disclosure provides methods for use in controlling a vehicle to reduce deceleration events on a road segment which can lead to traffic jams. In accordance with some embodiments, a computing device determines a target speed for a vehicle or a recommended lane for the vehicle and provides an indication of the target speed or recommended lane to the vehicle. Upon receiving the indication of the target speed or the recommended lane, the vehicle adjusts its current speed to minimize the difference between its current speed and the target speed or changes lanes into the recommended lane. Driving at the target speed or in the recommended lane causes the distance between each vehicle to increase and reduces the likelihood of the vehicle or other vehicles on the road segment having to suddenly brake which may cause a phantom traffic jam. By controlling the speed or the lane of the vehicle in this manner, the phantom traffic jam is able to dissipate.

As described above, phantom traffic jams may occur due to a chain reaction caused by one vehicle slowing down on a densely populated roadway. This causes the vehicle behind it to slow down even more and sets off a chain reaction of vehicles slowing down which acts like a traveling wave. The minimum traffic density or number of vehicles per unit of distance in which a traffic jam can occur on a road may be determined using the following equation:

$${ρ}_{L} = \frac{{ρ}_{M}}{2} ( 1 - \sqrt{1 - \frac{4 β}{{u}^{2}}} )$$

where:
ρ_{L} is the minimum traffic density or number of vehicles per unit of distance in which a traffic jam can occur on a road (e.g., where the unit is vehicles per mile),
ρ_{M} is the maximum traffic density for the particular road (e.g., where there is no space between vehicles on the road) (e.g., where the unit is vehicles per mile),
β is a measure of road conditions which decreases in accordance with the curvature of the road and/or the weather conditions, and
u is the speed at which vehicles travel on the road when there is no traffic, such as the speed limit or slightly above the speed limit (e.g., where the unit is miles per hour).

In this manner, as the average speed for vehicles traveling on the road without traffic increases, the minimum traffic density in which a traffic jam can occur decreases. Accordingly, phantom traffic jams may be likely to occur on roadways with higher speed limits such as highways, tollways, and expressways.

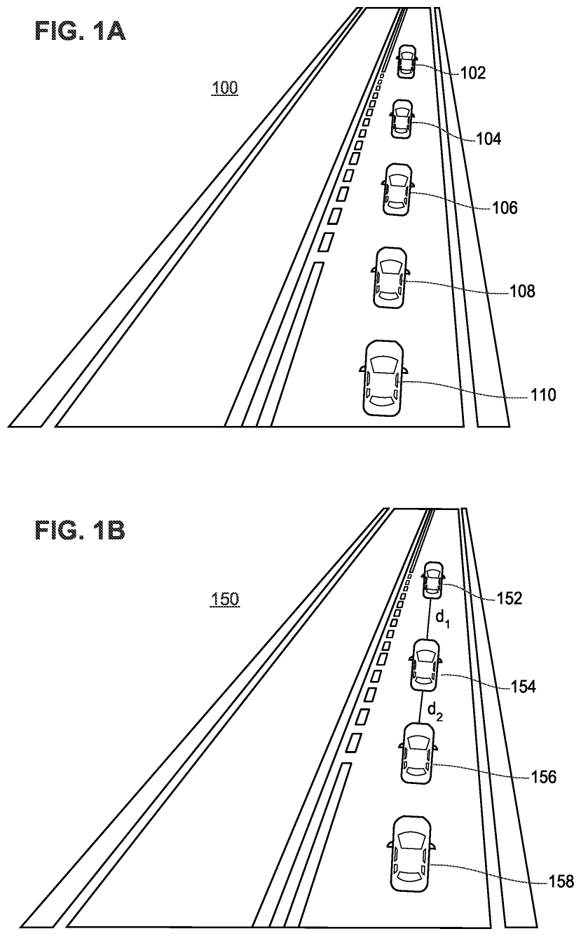

This phenomenon is illustrated in FIG. 1A which depicts an example roadway 100 with vehicles 102-110 traveling on the roadway. The roadway 100 does not include an intersection, traffic signal, accident, construction, lane closure, etc. However, a traffic jam is created along the roadway due to a second vehicle 104 following a first vehicle 102 too closely. When the first vehicle 102 slows down, the second vehicle 104 decelerates faster than the first vehicle 102 to avoid hitting the first vehicle 102. The third vehicle 106 decelerates faster than the second vehicle 104 and the fourth vehicle 108 decelerates even faster than the third vehicle 106. The fourth vehicle 108 then has to wait for the second vehicle 104 and the third vehicle 106 to speed up before the fourth vehicle 108 can accelerate once again. Accordingly, the traffic flow behaves as a traveling wave amplifying in magnitude the further a vehicle is from the first vehicle that slows down. As the fifth vehicle 110 approaches the roadway 100, the fifth vehicle 110 is also likely to follow the pattern of the first four vehicles. The fifth vehicle 110 may follow closely behind the fourth vehicle 108 and accelerate and decelerate in the same manner as the fourth vehicle 108.

On the other hand, when each vehicle maintains an equal distance between the vehicle and the vehicle in front of the vehicle and the vehicle and the vehicle behind the vehicle, these phantom traffic jams do not occur. This is illustrated in FIG. 1B which depicts an example roadway 150 with vehicles 152-158 traveling on the road. The second vehicle 154 on the roadway 150 maintains the same distance between the second vehicle 154 and first vehicle 152 (d₁) as the distance between the second vehicle 154 and the third vehicle 156 (d₂). As a fourth vehicle 158 approaches the third vehicle 156, the third vehicle 156 and the fourth vehicle 158 maintain the same distance as the distance between the third vehicle 156 and the second vehicle 154 (d₂).

Accordingly, to maintain an equal distance between the vehicle and the vehicle in front of the vehicle and the vehicle and the vehicle behind the vehicle (also referred to herein as “bilateral control”), the deceleration reduction system determines a target acceleration of a vehicle on the road segment or approaching the road segment at a particular point in time based on the speeds and positions of the vehicle, the vehicle in front of the vehicle, and the vehicle behind the vehicle. More specifically, the deceleration reduction system may determine the target acceleration (a) of the vehicle as:

$$a = {k}_{d} ( {x}_{n + 1} - 2 {x}_{n} + {x}_{n - 1} ) + {k}_{v} ( {v}_{n + 1} - 2 {v}_{n} + {v}_{n - 1} )$$

where:
xₙ is the position of vehicle n (e.g., where the unit is feet or miles),
xₙ₊₁ is the position of vehicle n+1 in front of vehicle n (e.g., where the unit is feet or miles),
xₙ₋₁ is the position of vehicle n−1 behind vehicle n (e.g., where the unit is feet or miles),
vₙ is the velocity of vehicle n (e.g., where the unit is feet per second or miles per hour),
vₙ₊₁ is the velocity of vehicle n+1 in front of vehicle n (e.g., where the unit is feet per second or miles per hour),
vₙ₋₁ is the velocity of vehicle n−1 behind vehicle n (e.g., where the unit is feet per second or miles per hour),
k_{d} is the gain of positional feedback, and
kᵥ is the gain of velocity feedback.

The deceleration reduction system may then determine a target speed for the vehicle to accelerate or decelerate to within a threshold time period (e.g., 10 seconds, 30 seconds, etc.) based on the vehicle's current speed, the target acceleration, and the threshold time period. The target speed may be presented on a user's client device 10 numerically or as a background color indicating that the user needs to speed up, slow down, or maintain a constant speed.

Additionally, the deceleration reduction system receives an indication of the vehicle's destination, for example from a user's client device or a vehicle head unit. The deceleration reduction system may then estimate the delay in the vehicle's ETA to the destination if the vehicle proceeds in its current manner and does not transition to the target speed. For example, the vehicle may take 2 minutes longer to reach its destination if it continues to travel at 40 mph on the road segment than if it slows down to 30 mph due to an increased number of deceleration events where the vehicle will need to stop and start again. The estimated delay in the ETA may also be presented on the user's client device 10 or provided to the vehicle head unit. As such, the presentation of the estimated delay in the ETA may be presented in conjunction with a recommendation or indication to reduce speed, rather than increase speed, due to a predicted reduced number of deceleration events occurring at the reduced speed. Such a recommendation is likely to be counterintuitive to the user, and as such this approach beneficially provides the user with a way of improving their ETA using a method the user wouldn't expect.

In addition to determining a target speed for the vehicle, the deceleration reduction system also may recommend a lane for the vehicle to move into to reduce the number of deceleration events for the vehicle. For example, when the road segment has multiple lanes, the deceleration reduction system may determine the average speeds of the vehicles in each lane. Then the deceleration reduction system may recommend that the vehicle moves into the lane having an average speed which is closest to the speed of the vehicle. This minimizes the total number of lane changes by other vehicles which can lead to deceleration events on the road segment causing a traffic jam. Additionally, this also allows the vehicle to continue traveling at or close to its current speed without having to substantially slow down or speed up to a target speed to maintain an appropriate following distance behind the vehicle in front of it. The recommendation may be such that the vehicle is recommended to move into a lane having a slower average speed compared to the current lane. As such, the comments in the paragraph above regarding the counterintuitive nature of the method apply equally here.

### Example Hardware and Software Components

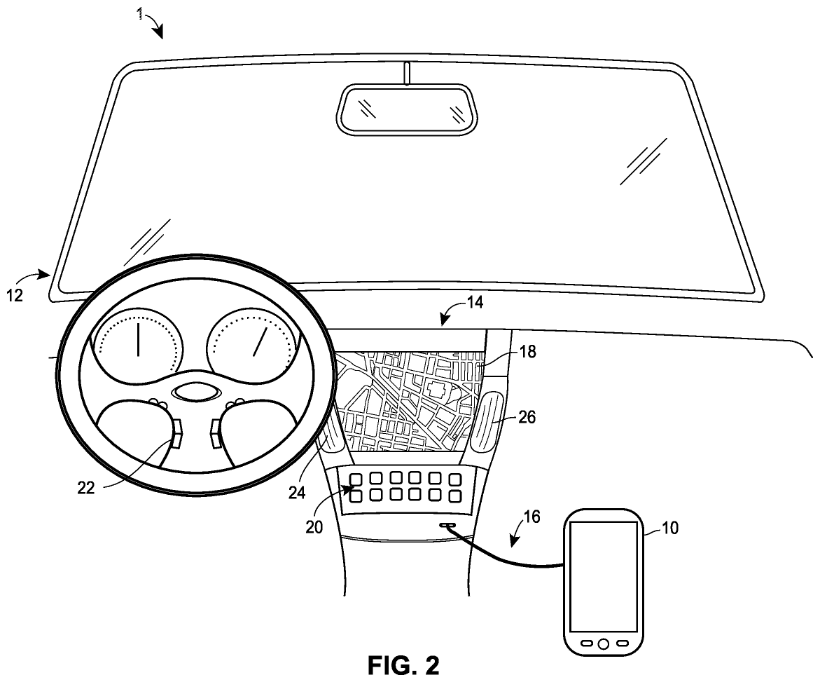

Referring to FIG. 2, an example environment 1 in which the techniques outlined above can be implemented includes a client device 10 and a vehicle 12 with a head unit 14. The client device 10 may be a smart phone or a tablet computer, for example. The client device 10 communicates with the head unit 14 of the vehicle 12 via a communication link 16, which may be wired (e.g., Universal Serial Bus (USB)) or wireless (e.g., Bluetooth, Wi-Fi Direct). The client device 10 also can communicate with various content providers, servers, etc. via a wireless communication network such as a fourth- or third-generation cellular network (4G or 3G, respectively).

The head unit 14 can include a display 18 such as a digital map. The display 18 in some implementations is a touchscreen and includes a software keyboard for entering text input, which may include the name or address of a destination, point of origin, etc. Hardware input controls 20 and 22 on the head unit 14 and the steering wheel, respectively, can be used for entering alphanumeric characters or to perform other functions for requesting navigation directions. The head unit 14 also can include audio input and output components such as a microphone 24 and speakers 26, for example. Additionally, the head unit 14 can include one or several sensors, such as a GPS module, an accelerometer, a gyroscope, a magnetometer such as a compass, an inertial measurement unit (IMU), etc.

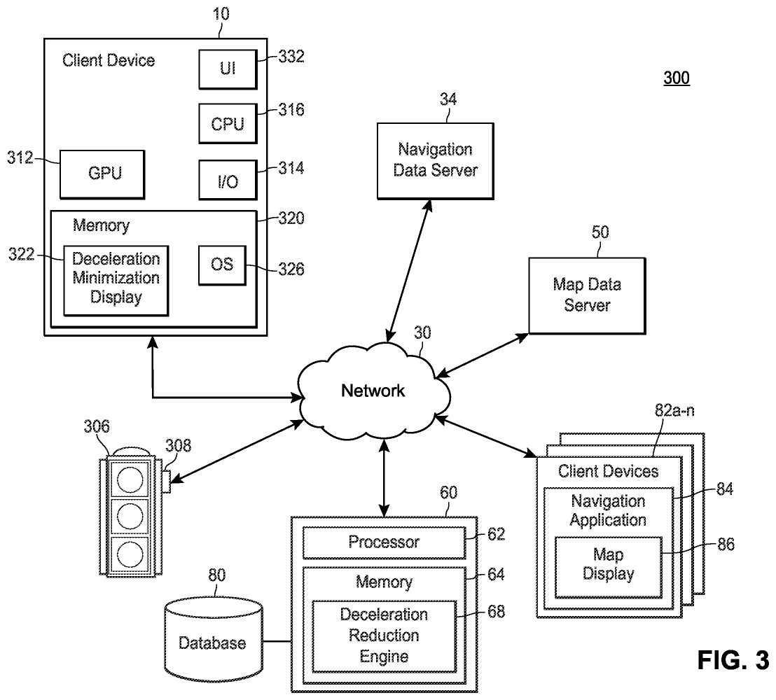

Referring to FIG. 3, an example communication system 300 in which a deceleration reduction system can be implemented includes a client device 10 and several other client devices 82a-n, such as a computing device configured to execute a geographic application 84, which also can be referred to as “navigation application 84.” Depending on the implementation, the application 84 can display an interactive digital map, request and receive routing data to provide driving, walking, or other navigation directions, provide various geolocated content, etc. Each of the client devices 82a-n may be operated by users displaying digital maps while navigating to various locations.

Furthermore, the example communication system 300 includes infrastructure components 306, such as traffic lights which are disposed on or around road segments and collect sensor data related to the road segments. The infrastructure components 306 may include traffic signals, cameras, street lights, or any other suitable roadside equipment. Furthermore, the infrastructure components 306 may include one or more sensors (not shown) such as a camera, a positioning sensor, etc., a processing component 308, and a vehicle-to-infrastructure (V2I) communication interface for communicating with vehicles within a communication range of the infrastructure component 306 and/or communicating with server devices.

In addition to the client device 10, the other client devices 82a-n, and the infrastructure components 306, the communication system 300 includes a server device 60 configured to provide a target speed, a recommended lane, and/or an indication of the delay in the ETA to the client device 10. The server device 60 can be communicatively coupled to a database 80 that stores, in an example implementation, sensor data received from the client device 10, the other client devices 82a-n and the infrastructure components 306 to identify a cluster of vehicles on a road segment and their respective positions, speeds, following distances, etc.

More generally, the server device 60 can communicate with one or several databases that store any type of suitable geospatial information or information that can be linked to a geographic context. The communication system 300 also can include a navigation data server 34 that provides driving, walking, biking, or public transit directions, for example. Further, the communication system 300 can include a map data server 50 that provides map data to the server device 60 for generating a map display. Still further, the communication system 300 can include a traffic server (not shown) that provides traffic data to the server device 60. The devices operating in the communication system 300 can be interconnected via a communication network 30.

The client device 10 and other client devices 82a-n may include a memory 320, one or more processors (CPUs) 316, a graphics processing unit (GPU) 312, an I/O module 314, a user interface (UI) 332, and one or several sensors (not shown), such as a global positioning system (GPS) module, an accelerometer, a gyroscope, a magnetometer such as a compass, etc. The client device 10 may also include a communication interface for communicating with other client devices 82a-n via a short-range communication link, such as Wi-Fi, Bluetooth, ultra-wideband (UWB), etc., and/or for communicating with server devices or other computing devices via a long-range communication link, such as the Internet.

The memory 320 can be a non-transitory memory and can include one or several suitable memory modules, such as random access memory (RAM), read-only memory (ROM), flash memory, other types of persistent memory, etc. The I/O module 14 may be a touch screen, for example. In various implementations, the client device 10 can include fewer components than illustrated in FIG. 3 or conversely, additional components. While the client device 10 is described above with reference to FIG. 1 as a smart phone or a tablet computer, the client device 10 may be any suitable portable or non-portable computing device. For example, the client device 10 may be a laptop computer, a desktop computer, a wearable device such as a smart watch or smart glasses, a virtual reality headset, a vehicle head unit, etc.

The memory 320 stores an operating system (OS) 326, which can be any type of suitable mobile or general-purpose operating system. The OS 326 can include application programming interface (API) functions that allow applications to retrieve sensor readings. For example, a software application configured to execute on the client device 10 can include instructions that invoke an OS 326 API for retrieving a current location of the client device 10 at that instant. The API can also return a quantitative indication of how certain the API is of the estimate (e.g., as a percentage).

The memory 320 also stores a deceleration minimization display 322, which can be included as functionality within a geographic application, such as a navigation application. The navigation application can display an interactive digital map, request and receive routing data to provide driving, walking, or other navigation directions, provide various geolocated content, etc. In some implementations, the current location of the client device 10 is provided to the server device 60. The navigation application may also provide other sensor data to the server device 60. For example, the navigation application may provide indications of the speed or acceleration of the vehicle 12 from the GPS or accelerometer. Additionally, the navigation application may determine the locations, speeds, and/or accelerations of other vehicles on the road segment.

For example, the navigation application may determine the locations of vehicles in front of and behind the vehicle by broadcasting a short-range communication signal, such as a Bluetooth or UWB signal, which may be received by vehicles within communication range of the vehicle 12. The vehicles may then respond to the short-range communication signal by reporting their locations, speeds, and/or accelerations to the client device 10.

In other implementations, the vehicles may transmit response messages to the client device 10 and the navigation application may determine the distance between the vehicle 12 and another vehicle based on the time of flight or the round trip time (RTT) of the short-range communication signal and the short-range response message. The navigation application can calculate RTT as T₁+T₂+T₃, where T₁ is the amount of time it takes for the short-range communication signal to be sent from the client device 10 to another vehicle, T₂ is the amount of time it takes for the other vehicle to generate a reply, and T₃ is the time duration in which the other vehicle sends the short-range response message back to the client device 10. Then, the navigation application can calculate the distance between the vehicle 12 and the other vehicle as ½ of c×(RTT−T₂), where c is the speed of light.

In some implementations, the client device 10 can be equipped with multiple antennas to determine not only the distance but also the direction of the other vehicle, so that the client device 10 can determine the whether the other vehicle is in front of or behind the vehicle 12 and can determine the precise location of the other vehicle based on the distance and direction. For example, the client device 10 may determine the direction of the other vehicle by receiving the short-range response message at each of its antennas, where the antennas are located at different positions within the client device 10. The client device 10 may then determine the direction of arrival of the short-range response message based on a time difference at which each of the antennas received the short-range response message.

In any event, the navigation application may provide locations, speeds, and/or accelerations of other vehicles on the road segment to the server device 60. The server device 60 may then analyze the locations, speeds, and/or accelerations of the vehicle 12 and the other vehicles to determine a target speed for the vehicle 12 and/or a recommended lane for the vehicle 12. In other implementations, the navigation application analyzes the locations, speeds, and/or accelerations of the vehicle 12 and the other vehicles to determine the target speed for the vehicle 12 and/or the recommended lane for the vehicle 12.

The deceleration minimization display 322 may then present the indication of the target speed, for example as a numeric indication (e.g., 33 mph), as a directional arrow (e.g., where an arrow pointing up indicates that the user should speed up and an arrow pointing down indicates that the user should slow down), and/or as a background color selected from a set of background colors that each represent different changes in speed. For example, a green background color may indicate that the user of the client device 10 needs to speed up, a blue background color may indicate that the user of the client device 10 needs to stay at the same speed, a yellow background color may indicate that the user of the client device 10 needs to slow down, and an orange background color may indicate that the user of the client device 10 needs to rapidly decelerate.

Additionally, the deceleration minimization display 322 may present the indication of the recommended lane with text or an arrow or other indicator highlighting the recommended lane within multiple lanes.

The deceleration minimization display 322 may be presented as a notification within the navigation application, and may be presented periodically overlaying the interactive digital map or continuously for the time period in which the client device 10 is approaching or is on the road segment. The server device 60 and/or the client device 10 may provide real-time updates of the target speed and/or the recommended lane for the vehicle 12 based on the locations, speeds, and/or accelerations of the vehicle 12 and the other vehicles on the road segment.

As mentioned above, each client device 82a-n may be operated by a user displaying map data. Each of the client devices 82a-n may be a smartphone or a tablet computer and may have one or several sensors. Additionally, each client device 82a-n may include a memory that stores an operating system (OS) and a navigation application 84 which is configured to generate interactive digital maps and/or perform other geographic functions, as indicated above. The navigation application 84 can receive map data in a raster (e.g., bitmap) or non-raster (e.g., vector graphics) format from the map data server 50 and present the map data via a map display 86. In some cases, the map data can be organized into layers, such as a basic layer depicting roads, streets, natural formations, etc., a traffic layer depicting current traffic conditions, a weather layer depicting current weather conditions, a navigation layer depicting a path to reach a destination, etc. The navigation application 84 also can display driving, walking, or transit directions, and in general provide functions related to geography, geolocation, navigation, etc. via the map display 86.

The client devices 82a-n may provide map data and/or sensor data to the server device 60 for identifying a cluster of vehicles and their respective positions/speeds on a road segment. More specifically, when a user of the client device 82a-n agrees to share location and other sensor data, the client device 82a-n provides positioning data indicating the current location of the client device 82a-n to the server device 60 as well as acceleration data and/or speed data for the client device 82a-n.

It is noted that although FIG. 3 illustrates the navigation application 84 as a standalone application, the functionality of the navigation application 84 also can be provided in the form of an online service accessible via a web browser executing on the client devices 82a-n, as a plug-in or extension for another software application executing on the client devices 82a-n, etc. The navigation application 84 generally can be provided in different versions for different respective operating systems. For example, the maker of the client devices 82a-n can provide a Software Development Kit (SDK) including the navigation application 84 for the Android™ platform, another SDK for the iOS™ platform, etc.

In some implementations, the server device 60 includes one or more processors 62 and a memory 64. The memory 64 may be tangible, non-transitory memory and may include any types of suitable memory modules, including random access memory (RAM), read-only memory (ROM), flash memory, other types of persistent memory, etc. The memory 64 stores instructions executable on the processors 62 that make up a deceleration reduction engine 68, which can receive a current location of a client device 10 and a destination location for the client device 10, and identify a cluster of vehicles on the same road segment as the client device 10 and their respective positions, speeds, and/or accelerations on the road segment. The deceleration reduction engine 68 may then determine a target speed or a recommended lane for the vehicle 12 associated with the client device 10 to reduce deceleration events on the road segment to minimize the ETA to the destination. Additionally, the deceleration reduction engine 68 may determine a delay in the ETA if the vehicle 12 continues to proceed in its current manner (e.g., by maintaining its current speed, current lane, or current following distance). The client device 10 may then display indications of the target speed, the recommended lane, and/or the delay in the ETA via the deceleration minimization display 322.

The deceleration reduction engine 68 and the deceleration minimization display 322 can operate as components of a deceleration reduction system. Alternatively, the deceleration reduction system can include only server-side components and simply provide the deceleration minimization display 322 with instructions to display an indication of the target speed, a recommended lane, and/or a delay in the ETA. In other words, deceleration reduction techniques in these embodiments can be implemented transparently to the deceleration minimization display 322. As another alternative, the entire functionality of the deceleration reduction engine 68 can be implemented in the deceleration minimization display 322. While the deceleration minimization display 322 is shown in FIG. 3 as operating in the client device 10, the deceleration minimization display 322 may also operate within a vehicle head unit 14 or in any other computing device operating in a vehicle 12. For example, the deceleration minimization display 322 may operate in a computing device that controls operation of the vehicle 12. In this manner, the server device 60 may provide indications of target speeds and recommended lanes for the vehicle 12 to the deceleration minimization display 322, and the computing device may control operation of the vehicle 12 to accelerate or decelerate to achieve the desired speeds and to move into the recommended lanes.

For simplicity, FIG. 3 illustrates the server device 60 as only one instance of a server. However, the server device 60 according to some implementations includes a group of one or more server devices, each equipped with one or more processors and capable of operating independently of the other server devices. Server devices operating in such a group can process requests from the client device 10 individually (e.g., based on availability), in a distributed manner where one operation associated with processing a request is performed on one server device while another operation associated with processing the same request is performed on another server device, or according to any other suitable technique. For the purposes of this discussion, the term “server device” may refer to an individual server device or to a group of two or more server devices.

In operation, the deceleration minimization display 322 operating in the client device 10 receives and transmits data to the server device 60. Thus, in one example, the client device 10 may transmit a communication to the deceleration reduction engine 68 (implemented in the server device 60) indicating the current location of the client device 10 and a destination for the client device 10. The client device 10 may also provide sensor data from the vehicle 12 to the deceleration reduction engine 68 indicating the speed of the vehicle 12, the acceleration of the vehicle 12, etc. Furthermore, the client device 10 may provide indications of the locations, speeds, and/or accelerations of other vehicles on the road segment to the deceleration reduction engine 68.

As mentioned above, the client device 10 may determine the locations, speeds, and/or accelerations of the other vehicles by transmitting and receiving short-range communications to and from the other vehicles. The other vehicles may report their locations, speeds, and/or accelerations in the short-range communications or the client device 10 may determine their locations, speeds, and/or accelerations based on the RTT for transmitting and receiving short-range communications to and from the other vehicles.

In yet other implementations, the client device 10 may receive sensor data from sensors in the vehicle 12 which indicate the distance between the vehicle 12 and other vehicles on the road segment. For example, the vehicle 12 may include front-facing and back-facing depth sensors, such as light detection and ranging (LiDAR) sensors, radio detection and ranging (RADAR) sensors, etc. The depth data detected by the front-facing and back-facing depth sensors may be provided to the client device 10. The client device 10 may then determine the position of the other vehicles based on the depth data. The implementations which include depth sensors may not use short-range communications to determine the locations, speeds, and/or accelerations of other vehicles and the implementations which include short-range communications may not include depth sensors.

Additionally, the deceleration reduction engine 68 may receive sensor data from the client devices 82a-n executing navigation applications 84 indicating the locations, speeds, and/or accelerations of the vehicles corresponding to the client devices 82a-n.

In any event, the deceleration reduction engine 68 may identify a cluster of vehicles on the road segment, where the cluster includes the vehicle 12. The deceleration reduction engine 68 may also identify the respective positions of the vehicles within the cluster. To identify the cluster, the deceleration reduction engine 68 may filter the location data received for vehicles on the road segment to only include a subset of the vehicles which are within a threshold distance of the vehicle 12. The threshold distance may be a distance in the direction of the road segment so that vehicles within the threshold distance (e.g., 0.5 miles) ahead of the vehicle 12 or within the threshold distance behind the vehicle 12 are included in the cluster even if they are not in the same lane as the vehicle 12. The subset may also be filtered to only include vehicles traveling in the same direction as the vehicle 12. For example, if the vehicle 12 is headed eastbound, vehicles traveling westbound may not affect the vehicle's 12 ETA and are not included in the cluster.

In other implementations, the deceleration reduction engine 68 identifies the cluster without specifying a threshold distance around the vehicle 12. Instead, the deceleration reduction engine 68 may use an unsupervised machine learning algorithm such as a clustering algorithm (e.g., k-means clustering) to identify clusters of vehicles on the road segment which are proximate to each other. Then the deceleration reduction engine 68 may identify one of the clusters which includes the vehicle 12 as the identified cluster.

In any event, the deceleration reduction engine 68 may analyze the locations, speeds, and/or accelerations of the vehicles in the cluster to determine a target speed and/or recommended lane for the vehicle 12. In some implementations, the deceleration reduction engine 68 determines a target speed for the vehicle 12 using bilateral control methods, where the target speed is determined to maintain a threshold distance between the vehicle 12 and the vehicles in front of and behind the vehicle 12. The deceleration reduction engine 68 determines a target acceleration for the vehicle 12 using the equation described above, where:

$$a = {k}_{d} ( {x}_{n + 1} - 2 {x}_{n} + {x}_{n - 1} ) + {k}_{v} ( {v}_{n + 1} - 2 {v}_{n} + {v}_{n - 1} )$$

The deceleration reduction engine 68 may include pre-stored values for k_{d}, the gain of positional feedback, and kᵥ, the gain of velocity feedback. The deceleration reduction engine 68 then determines the target speed for the vehicle 12 to accelerate or decelerate to within a threshold time period (e.g., 10 seconds, 30 seconds, etc.) based on the vehicle's 12 current speed, the target acceleration, and the threshold time period.

The deceleration reduction engine 68 may determine a recommended lane for the vehicle 12 by determining the average speed of the vehicles in the cluster in each lane of the road segment. For example, if the road segment includes three lanes, the deceleration reduction engine 68 may determine the average speed of the vehicles in the cluster in the left lane, the average speeds of the vehicles in the cluster in the center lane, and the average speed of the vehicles in the cluster in the right lane. Then the deceleration reduction engine 68 may recommend a lane having an average speed which is closest to the current speed of the vehicle 12.

In this manner, if the vehicle 12 is traveling at a speed which is significantly below the average speed for the lane, the deceleration reduction engine 68 can recommend another lane for the vehicle 12 to prevent deceleration events from other vehicles trying to pass the vehicle 12. If the vehicle 12 is traveling at a speed which is significantly above the average speed for the lane, the deceleration reduction engine 68 can recommend another lane for the vehicle 12 to prevent deceleration events from the vehicle 12 getting too close to other vehicles in the lane.

The deceleration reduction engine 68 may also generate a model of the traffic flow based on the respective positions, speeds, and/or accelerations of the vehicles in the cluster, for example using known traffic modeling methods, such as macroscopic, mesoscopic, and microscopic models. More specifically, the traffic flow at a particular point may be calculated as the number of vehicles that pass through the particular point in a particular time frame. The traffic density may be calculated as the number of vehicles per unit of distance on the road segment. The average speed on the road segment may be calculated by dividing the traffic flow over the traffic density. By traveling at the target speed, traffic flow may improve which increases the average speed on the road segment.

The deceleration reduction engine 68 may use the model of the traffic flow to determine a first ETA for the vehicle 12 to arrive at its destination under the current traffic patterns. For example, the deceleration reduction engine 68 may communicate with the navigation data server 34 to obtain a set of navigation directions to the destination. Then the deceleration reduction engine 68 may determine the first ETA based on the set of navigation directions and the current traffic patterns. More specifically, the current traffic patterns may indicate an average speed of 20 mph on the road segment, and the set of navigation directions may indicate that the vehicle 12 will travel on the road segment for 10 more miles before arriving at the destination. Accordingly, the deceleration reduction engine 68 may determine that the first ETA is 30 minutes.

Additionally, the deceleration reduction engine 68 may adjust the model of the traffic flow to account for the vehicle 12 traveling at the target speed and/or in the recommend lane. Then the deceleration reduction engine 68 may use the adjusted model of the traffic flow to determine a second ETA for the vehicle 12 to arrive at its destination traveling at the target speed/in the recommended lane. For example, the deceleration reduction engine 68 may determine the second ETA based on the set of navigation directions and the adjusted traffic patterns. More specifically, the adjusted traffic patterns may indicate an average speed of 30 mph due to a significantly reduced number of deceleration events where the vehicle 12 comes to a complete stop and does not reach its peak speed again for a long time. As mentioned above, the set of navigation directions may indicate that the vehicle 12 will travel on the road segment for 10 more miles before arriving at the destination. Accordingly, the deceleration reduction engine 68 may determine that the second ETA is 20 minutes.

The deceleration reduction engine 68 may compare the first and second ETAs to determine the delay in the ETA if the vehicle 12 continues to proceed in its current manner (e.g., by maintaining its current speed, current lane, or current following distance). In the example above, the deceleration reduction engine 68 may determine that the delay in the ETA is 10 minutes if the vehicle 12 continues to proceed in its current manner.

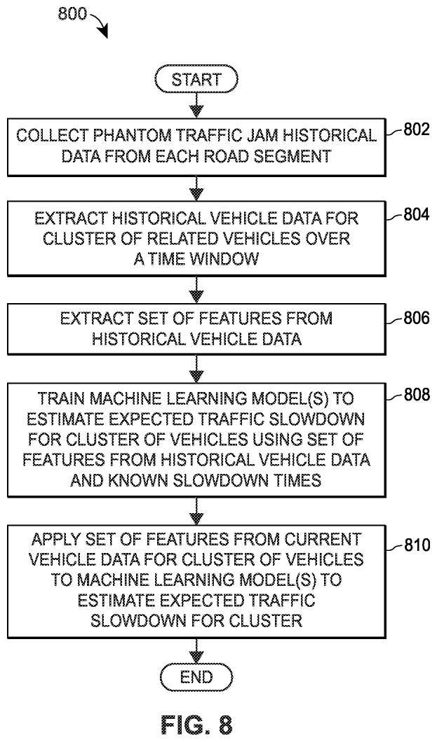

An example method for generating and applying machine learning models to estimate traffic flow and determine the delay in the ETA is described in more detail below with reference to FIG. 8.

In any event, the deceleration reduction engine 68 then provides indications of the target speed, the recommended lane, and/or the delay in the ETA to the deceleration minimization display 322. In some implementations, the indication of the target speed is a numeric indication or a background color from a set of background colors. In other implementations, the indication of the target speed may be a feedback signal indicative of the difference between the target speed and the current speed. The feedback signal may be provided to a computing device within the vehicle 12 that controls some operation of the vehicle 12 (e.g., a throttle control), such as a computing device in an autonomous vehicle, a semi-autonomous vehicle, or any other vehicle having autonomous operation features. In this manner, the computing device may control the vehicle 12 to adjust the speed and travel at the target speed.

The indication of the recommended lane may be a textual indication or an arrow or other indicator highlighting the recommended lane within multiple lanes. In other implementations, the indication of the recommended lane may be a feedback signal indicative of the position of recommended lane relative to the current lane. The feedback signal may be provided to a computing device within the vehicle 12 that controls some operation of the vehicle 12 (e.g., steering control), such as a computing device in an autonomous vehicle, a semi-autonomous vehicle, or any other vehicle having autonomous operation features. In this manner, the computing device may control the vehicle 12 to steer into the recommended lane.

As mentioned above, each of the functions performed by the deceleration reduction engine 68 may be performed by the deceleration minimization display 322 at the client device 10. For example, the deceleration minimization display 322 may generate a model of the traffic flow based on the respective positions, speeds, and/or accelerations of the vehicles in the cluster, and may use the model to determine the first and second ETAs.

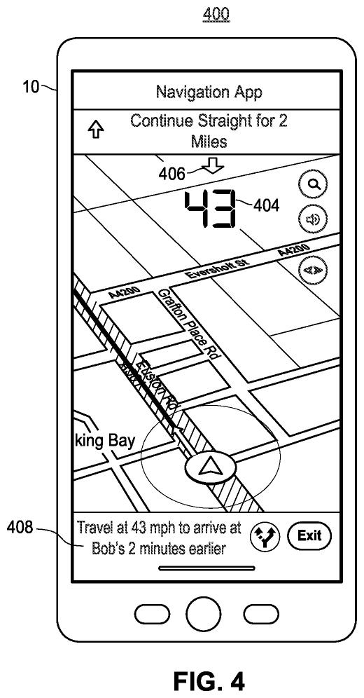

FIGS. 4-7 include example navigation displays 400-700 indicating target speeds and recommended lanes for a vehicle 12. The navigation displays 400-700 may be presented on the user interface 332 of the client device 10 or on a vehicle head unit 14.

More specifically, FIG. 4 includes an example navigation display 400 which includes a numeric indication of the target speed 404 for the vehicle 12. The navigation display 400 also includes another indicator 406 regarding whether the vehicle should speed up, slow down, stay at the same speed, etc., such as a directional arrow. Still further, the navigation display 400 include an indication 408 of the delay in the ETA if the vehicle 12 continues to proceed in its current manner (e.g., by maintaining its current speed, current lane, or current following distance). The indication 408 is a textual indication which states, “Travel at 43 mph to arrive at Bob's 2 minutes earlier.” In other implementations, the indication 408 may be a first numerical indication of the first ETA if the vehicle 12 travels in the current manner, a second numerical indication of the second ETA if the vehicle 12 travels at the target speed, and/or a third numerical indication of the difference between the first and second ETAs.

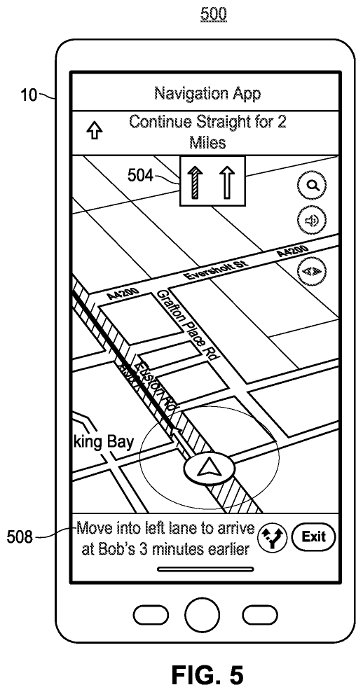

FIG. 5 includes another example navigation display 500 which includes an arrow highlighting a recommended lane 504 for the vehicle 12 (e.g., the left lane). The navigation display 500 also includes an indication 508 of the delay in the ETA if the vehicle 12 continues to proceed in its current manner (e.g., by maintaining its current speed, current lane, or current following distance). The indication 508 is a textual indication which states, “Move into left lane to arrive at Bob's 3 minutes earlier.” In other implementations, the indication 508 may be a first numerical indication of the first ETA if the vehicle 12 travels in the current manner, a second numerical indication of the second ETA if the vehicle 12 travels in the recommended lane, and/or a third numerical indication of the difference between the first and second ETAs.

In some scenarios, the deceleration reduction engine 68 may not recommend a lane change. For example, the client device 10 may detect that the vehicle is making frequent lane changes based on the sensor data indicating acceleration events to and from adjacent lanes which are occurring at a frequency above a frequency threshold. The client device 10 may provide an indication of the frequent lane changes to the server device 60. In response to receiving the indication, the deceleration reduction engine 68 may compare distances traveled over a time period from a first set of vehicles ahead of the vehicle 12 in the cluster which are not making frequent lane changes to distances traveled over the same time period from a second set of vehicles also ahead of the vehicle 12 in the cluster which are making frequent lane changes. The deceleration reduction engine 68 may then estimate the amount of time saved by making frequent lane changes based on the excess distance traveled over the time period for the second set of vehicles making frequent lane changes.

When the second set of vehicles have not traveled further than the first set or the first set of vehicles have traveled further than the second set, the deceleration reduction engine 68 may recommend that the vehicle 12 remains in their current lane and does not continue to make frequent lane changes. On the other hand, when the second set of vehicles have traveled further than the first set, the deceleration reduction engine 68 may provide an indication of the time saved by continuing with frequent lane changes (e.g., “Our model predicts that lane changing will get you to your destination 30 seconds earlier”).

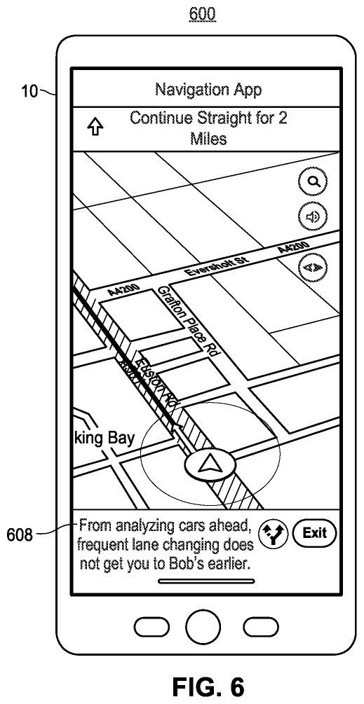

FIG. 6 illustrates an example navigation display 600 which includes an indication 608 of the delay in the ETA if the vehicle 12 continues to proceed in its current manner (e.g., by maintaining its current speed, current lane, or current following distance). More specifically, the navigation display 600 indicates 608 that the vehicle 12 should stop making frequent lane changes as it is not reducing the vehicle's 12 ETA. The indication 608 is a textual indication which states, “From analyzing cars ahead, frequent lane changing does not get you to Bob's earlier.”

Also in some scenarios, the deceleration reduction engine 68 may recommend a timing for a lane change when several vehicles are making the same lane change, for example when a lane closes. When each of the vehicles are making the same lane change, several deceleration events may occur because different vehicles have different behaviors where some vehicles change lanes too early and others change lanes too late. To reduce these deceleration events, the deceleration reduction engine 68 may recommend a timing for the vehicle 12 to change lanes, so that each of the vehicles merge at the correct time in zipper fashion, thereby maximizing vehicle throughput on the road segment.

To recommend the timing, the deceleration reduction engine 68 may identify vehicles ahead of the vehicle 12 on the road segment which have not yet made the lane change. For example, the deceleration reduction engine 68 may identify the vehicles by receiving communications from the client devices 82a-82n executing the navigation application 84 or by receiving indications of the locations of the vehicles from the client device 10. Then the deceleration reduction engine 68 may determine that each vehicle ahead of the vehicle 12 should stagger their lane change by the same threshold amount of time (e.g., 15 seconds, 30 seconds, etc.). The deceleration reduction engine 68 may multiply the number of vehicles ahead of the vehicle 12 by the threshold amount of time to determine the time for the vehicle 12 to change lanes. For example, if there is one vehicle ahead of the vehicle 12 and threshold amount of time is 15 seconds, then the vehicle ahead of the vehicle 12 should change lanes now and the vehicle 12 should change lanes 15 seconds from now. However, this is merely one exemplary method for determining the timing. The deceleration reduction engine 68 may determine the timing for a lane change in any suitable manner.

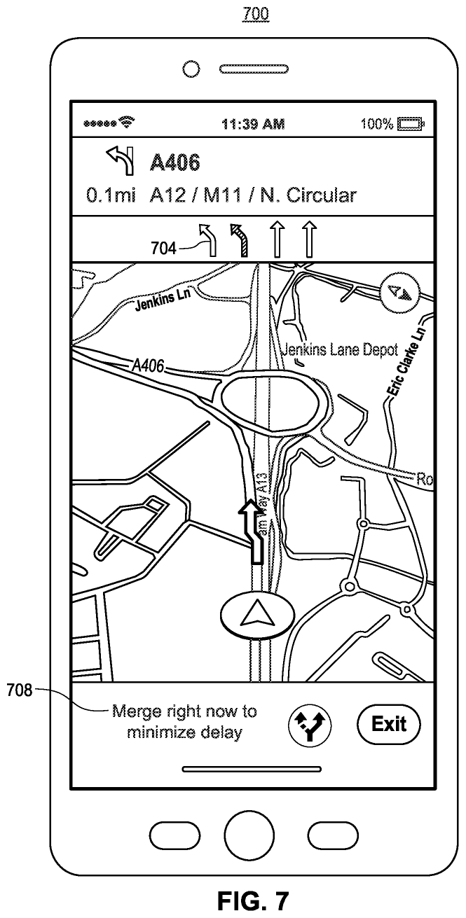

FIG. 7 illustrates an example navigation display 700 which includes an arrow highlighting a recommended lane 704 for the vehicle 12 (e.g., the left-center lane). The navigation display 700 also includes an indication 708 of the timing for the vehicle 12 to move into the left-center lane to reduce deceleration events from changing lanes. The indication 708 is a textual indication which states, “Merge right now to minimize delay.” In other implementations, the indication 708 may be a numerical indication or a countdown clock indicating the exact time to change lanes (e.g., in 30 seconds, in 10 seconds, in 1 minute, etc.). The navigation display 700 may also include an indication of the delay in the ETA if the vehicle does not move into the recommended lane 704 and/or if the vehicle 12 moves into the recommended lane 704 too soon or too late. For example, in addition to the countdown clock, the navigation display 700 may present numerical indications of the ETA if the vehicle 12 moves into the recommended lane at the current time and the ETA if the vehicle 12 moves into the recommended lane at the recommended time. The numerical indications may update as the countdown clock changes.

FIG. 8 illustrates an example method 800 for determining an expected traffic slowdown for a cluster of vehicles on a road segment using machine learning models which can be implemented at a network server (such as the server device 60), for example. The method can be implemented in a set of instructions stored on a computer-readable memory and executable at one or more processors of the server device 60. For example, the method can be implemented by the deceleration reduction engine 68.

At block 802, the deceleration reduction engine 68 collects phantom traffic jam historical data from several road segments. For each road segment, the phantom traffic jam historical data may include a slowdown time for vehicles on the road segment (e.g., 5 minutes, 10 minutes, 15 minutes, etc.), the number of vehicles on the road segment, the number of lanes on the road segment, the speeds of vehicles on the road segment, accelerations of vehicles on the road segment, following distances of vehicles on the road segment, lane changing events of vehicles on the road segment, or other vehicle data on the road segment.

Then at block 804, the deceleration reduction engine 68 extracts historical vehicle data from the phantom traffic jam historical data for each cluster of related vehicles over a particular time window (e.g., 10 minutes, 30 minutes, an hour, etc.). For example, the deceleration reduction engine 68 may cluster the vehicles using the clustering methods described above to identify a cluster of vehicles within the particular time window. Then the deceleration reduction engine 68 may generate a set of features for each cluster of vehicles using the historical vehicle data (block 806). For example, the set of features may include an average following distance in the cluster, a variance in the following distances in the cluster, an average speed in the cluster, a difference between the maximum and minimum speeds in the cluster, a total number of lane changes in the cluster, an average number of lane changes per vehicle in the cluster, etc.

The generated set of features may then be used as training data to train a machine learning model(s) to estimate the expected traffic slowdown for a cluster of vehicles on a road segment (block 808). The deceleration reduction engine 68 may apply supervised learning and classify each cluster and its corresponding set of features according to the historical slowdown time for the cluster. For example, some clusters may not have had any delays resulting in a slowdown time of zero minutes. Other clusters may have had some delays resulting in slowdown times between two and five minutes. Yet other clusters may have had significant delays resulting in slowdown times between ten and fifteen minutes. In other embodiments, other machine learning models may be trained, for example using unsupervised learning.

Then the deceleration reduction engine 68 may generate the machine learning model(s) based on the set of features from the historical vehicle data and historical slowdown times for each cluster. In some implementations, each of the clusters may be classified according to the historical slowdown time (e.g., a first set of clusters having a first slowdown time or range of slowdown times may be classified into a first group, a second set of clusters having a second slowdown time or range of slowdown times may be classified into a second group, etc.). The deceleration reduction engine 68 may then analyze the sets of features for the clusters in each group to optimize a set of machine learning model(s).

The deceleration reduction engine 68 may then obtain a set of features using current vehicle data for a cluster of vehicles currently on the road segment, where the slowdown time is unknown. For example, the deceleration reduction engine 68 may obtain a set of features for a cluster of vehicles which includes the vehicle 12. The deceleration reduction engine 68 may apply the set of features to the machine learning model(s) using machine learning techniques (block 810). The machine learning techniques may include linear regression, polynomial regression, logistic regression, random forests, boosting such as adaptive boosting, gradient boosting, and extreme gradient boosting, nearest neighbors, Bayesian networks, neural networks, support vector machines, or any other suitable machine learning technique. In an example embodiment, the difference (i.e., slowdown) in ETA is generated by the machine learning models with confidence scores. The confidence scores may then be compared to a confidence threshold to generate the difference in ETA.

The machine learning model(s) may then provide an expected slowdown time for the vehicles in the cluster if the vehicles proceed in the current manner, for example with a confidence score. The deceleration reduction engine 68 may use the expected slowdown time to determine a first ETA for the vehicle 12 to arrive at its destination under the current traffic patterns.

Additionally, the deceleration reduction engine 68 may adjust the set of features to account for the vehicle 12 traveling at the target speed and/or in the recommended lane. Then the deceleration reduction engine 68 may apply the adjusted set of features to the machine learning model(s) to determine an adjusted slowdown time if the vehicle 12 travels at the target speed and/or in the recommended lane. Then the deceleration reduction engine 68 may use the adjusted slowdown time to determine a second ETA for the vehicle 12 to arrive at its destination traveling at the target speed/in the recommended lane. The deceleration reduction engine 68 may compare the first and second ETAs to determine the delay in the ETA if the vehicle 12 continues to proceed in its current manner (e.g., by maintaining its current speed, current lane, or current following distance).

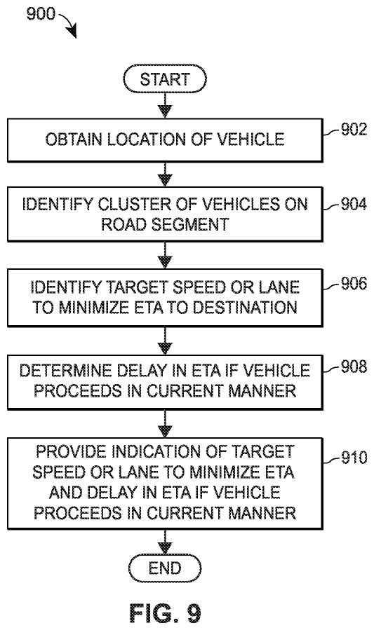

FIG. 9 illustrates an example method 900 for controlling a vehicle to reduce traffic on a road segment which can be implemented at a network server (such as the server device 60), for example. The method can be implemented in a set of instructions stored on a computer-readable memory and executable at one or more processors of the server device 60. For example, the method can be implemented by the deceleration reduction engine 68.

At block 902, the deceleration reduction engine 68 obtains a location of a client device 10 in a vehicle 12. The deceleration reduction engine 68 may also obtain a destination for the client device 10, and sensor data from the vehicle 12 indicating the speed of the vehicle 12, the acceleration of the vehicle 12, etc. Furthermore, the deceleration reduction engine 68 may obtain indications of the locations, speeds, and/or accelerations of other vehicles on the road segment.

Then at block 904, the deceleration reduction engine 68 identifies a cluster of vehicles on the road segment, where the cluster includes the vehicle 12. The deceleration reduction engine 68 may also identify the respective positions of the vehicles within the cluster. To identify the cluster, the deceleration reduction engine 68 may filter the location data received for vehicles on the road segment to only include a subset of the vehicles which are within a threshold distance of the vehicle 12. In other implementations, the deceleration reduction engine 68 identifies the cluster without specifying a threshold distance around the vehicle 12. Instead, the deceleration reduction engine 68 may use an unsupervised machine learning algorithm such as a clustering algorithm (e.g., k-means clustering) to identify clusters of vehicles on the road segment which are proximate to each other. Then the deceleration reduction engine 68 may identify one of the clusters which includes the vehicle 12 as the identified cluster.

At block 906, the deceleration reduction engine 68 identifies a target speed or a recommended lane for the vehicle 12 to minimize an ETA to the destination. To minimize the ETA, the deceleration reduction engine 68 identifies a target speed or a recommended lane to minimize the number of deceleration events on the road segment, thereby minimizing traffic on the road segment. For example, the deceleration reduction engine 68 may determine a target speed for the vehicle 12 using bilateral control methods, where the target speed is determined to maintain a threshold distance between the vehicle 12 and the vehicles in front of and behind the vehicle 12. The deceleration reduction engine 68 may determine a recommended lane for the vehicle 12 by determining the average speed of the vehicles in the cluster in each lane of the road segment. Then the deceleration reduction engine 68 may recommend a lane having an average speed which is closest to the current speed of the vehicle 12.

The deceleration reduction engine 68 may then determine a delay in the ETA if the vehicle continues to proceed in the current manner (e.g., by maintaining its current speed, current lane, or current following distance) (block 908). For example, the deceleration reduction engine 68 may generate a model of the traffic flow based on the respective positions, speeds, and/or accelerations of the vehicles in the cluster, and may use the model of the traffic flow to determine a first ETA for the vehicle 12 to arrive at its destination under the current traffic patterns. Additionally, the deceleration reduction engine 68 may adjust the model of the traffic flow to account for the vehicle 12 traveling at the target speed and/or in the recommend lane, and may use the adjusted model of the traffic flow to determine a second ETA for the vehicle 12 to arrive at its destination traveling at the target speed/in the recommended lane. The deceleration reduction engine 68 may then compare the first and second ETAs to determine the delay in the ETA if the vehicle 12 continues to proceed in its current manner.

More specifically, the deceleration reduction engine 68 may generate the model of the traffic flow using the method 800 described above with reference to FIG. 8 to determine the delay in the ETA which may include confidence scores. For example, the deceleration reduction engine 68 may determine multiple sets of features based on different speeds and lanes for the vehicle 12, and may apply each set of features to the machine learning model(s) to determine an expected slowdown time and/or confidence score for each set of features. Then the deceleration reduction engine 68 may select the speed and/or lane for the vehicle 12 having the lowest expected slowdown time. In some scenarios, the slowdown time may be negative indicating that the deceleration reduction engine 68 identifies a target speed and/or recommended lane which lowers the ETA.

At block 910, the deceleration reduction engine 68 provides indications of the target speed, the recommended lane, and/or the delay in the ETA to the deceleration minimization display 322. In this manner, a user may adjust the speed and/or the lane for the vehicle 12 accordingly, or a vehicle having autonomous operation features may automatically adjust its speed or change lanes.

### ADDITIONAL CONSIDERATIONS

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for controlling the vehicle through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for controlling a vehicle to reduce traffic on a road segment, the method comprising:
obtaining, at one or more processors, an indication of a location of a vehicle on a road segment traveling to a destination;
identifying, by the one or more processors, a cluster of vehicles including the vehicle on the road segment and respective positions of the vehicles in the cluster;
identifying, by the one or more processors, a particular speed or a particular lane for the vehicle which minimizes an estimated time of arrival (ETA) at the destination based on the respective positions of the vehicles in the cluster;
determining, by the one or more processors, a delay in the ETA if the vehicle proceeds at a current speed, in a current lane, or at a current following distance from a vehicle directly in front of the vehicle; and
providing, by the one or more processors, (i) an indication of the particular speed or the particular lane for the vehicle which minimizes the ETA, and (ii) an indication of the delay in the ETA if the vehicle proceeds at the current speed, in the current lane, or at the current following distance.

2. The method of claim 1, further comprising:
determining, by the one or more processors, a timing for when to merge into another lane to minimize delay caused by the merge; and
providing, by the one or more processors, an indication of the timing.

3. The method of claim 1, wherein providing an indication of the particular speed for the vehicle includes:
providing, by the one or more processors, the indication of the particular speed for display on a client device of a user within the vehicle or a vehicle head unit.

4. The method of claim 1, wherein providing an indication of the particular speed for the vehicle includes:
providing, by the one or more processors, the indication of the particular speed to a computing device operating in the vehicle having autonomous operation features for adjusting a speed of the vehicle.

5. The method of claim 1, further comprising:
determining, by the one or more processors, the current speed of the vehicle; and
for each of a plurality of lanes in the road segment, determining, by the one or more processors, an average speed of a subset of the vehicles in the cluster traveling in the lane;
wherein identifying the particular lane for the vehicle includes identifying one of the plurality of lanes having an average speed that is closest to the current speed of the vehicle.

6. The method of claim 1, further comprising:
determining, by the one or more processors, that the vehicle has made more than a threshold number of lane changes;
comparing, by the one or more processors, a first subset of vehicles in the cluster which have made more than the threshold number of lane changes to a second subset of vehicles in the cluster which have not made more than the threshold number of lane changes;
determining, by the one or more processors, a reduction in the ETA from frequent lane changes based on the comparison; and
providing, by the one or more processors, an indication of the reduction in the ETA from the frequent lane changes.

7. The method of claim 1, wherein the particular speed or the particular lane for the vehicle is identified to reduce a number of deceleration events performed by the vehicle.

8. The method of claim 1, wherein identifying a cluster of vehicles on the road segment includes:
at least one of: (i) obtaining sensor data from the vehicle indicating positions or speeds of vehicles on the road segment within a threshold range of the vehicle, or (ii) obtaining position or speed data from client devices within vehicles on the road segment executing a mapping application; and
identifying, by the one or more processors, the cluster of vehicles on the road segment based on at least one of the obtained sensor data, the obtained position data, or the obtained speed data.

9. The method of claim 1, wherein identifying the particular speed or the particular lane for the vehicle which minimizes the ETA includes:
generating, by the one or more processors, a model of traffic flow based on the respective positions and respective speeds of the vehicles in the cluster; and
identifying, by the one or more processors, the particular speed or the particular lane for the vehicle which minimizes the ETA using the model of traffic flow on the road segment.

10. A computing device for controlling a vehicle to reduce traffic on a road segment, the computing device comprising:
one or more processors; and
a computer-readable memory coupled to the one or more processors and storing instructions thereon that, when executed by the one or more processors, cause the computing device to:
obtain an indication of a location of a vehicle on a road segment traveling to a destination;
identify a cluster of vehicles including the vehicle on the road segment and respective positions of the vehicles in the cluster;
identify a particular speed or a particular lane for the vehicle which minimizes an estimated time of arrival (ETA) at the destination based on the respective positions of the vehicles in the cluster;
determine a delay in the ETA if the vehicle proceeds at a current speed, in a current lane, or at a current following distance from a vehicle directly in front of the vehicle; and
provide (i) an indication of the particular speed or the particular lane for the vehicle which minimizes the ETA, and (ii) an indication of the delay in the ETA if the vehicle proceeds at the current speed, in the current lane, or at the current following distance.

11. The computing device of claim 10, wherein the instructions further cause the computing device to:
determine a timing for when to merge into another lane to minimize delay caused by the merge; and
provide an indication of the timing.

12. The computing device of claim 10, wherein the indication of the particular speed is provided for display on a client device of a user within the vehicle or a vehicle head unit.

13. The computing device of claim 10, wherein the indication of the particular speed is provided to a computing device operating in the vehicle having autonomous operation features for adjusting a speed of the vehicle.

14. The computing device of claim 10, wherein the instructions further cause the computing device to:
determine the current speed of the vehicle; and
for each of a plurality of lanes in the road segment, determine an average speed of a subset of the vehicles in the cluster traveling in the lane;
wherein to identify the particular lane for the vehicle, the instructions cause the computing device to identify one of the plurality of lanes having an average speed that is closest to the current speed of the vehicle.

15. The computing device of claim 10, wherein the instructions further cause the computing device to:
determine that the vehicle has made more than a threshold number of lane changes;
compare a first subset of vehicles in the cluster which have made more than the threshold number of lane changes to a second subset of vehicles in the cluster which have not made more than the threshold number of lane changes;
determine a reduction in the ETA from frequent lane changes based on the comparison; and
provide an indication of the reduction in the ETA from the frequent lane changes.

16. The computing device of claim 10, wherein the particular speed or the particular lane for the vehicle is identified to reduce a number of deceleration events performed by the vehicle.

17. The computing device of claim 10, wherein the cluster of vehicles on the road segment is identified based on at least one of: (i) sensor data from the vehicle indicating positions or speeds of vehicles on the road segment within a threshold range of the vehicle, or (ii) position or speed data from client devices within vehicles on the road segment executing a mapping application.

18. The computing device of claim 10, wherein to identify the particular speed or the particular lane for the vehicle which minimizes the ETA, the instructions cause the computing device to:
generate a model of traffic flow based on the respective positions and respective speeds of the vehicles in the cluster; and
identify the particular speed or the particular lane for the vehicle which minimizes the ETA using the model of traffic flow on the road segment.

19. A computer-readable memory coupled to one or more processors and storing instructions thereon that, when executed by the one or more processors, cause the one or more processors to:
obtain an indication of a location of a vehicle on a road segment traveling to a destination;
identify a cluster of vehicles including the vehicle on the road segment and respective positions of the vehicles in the cluster;
identify a particular speed or a particular lane for the vehicle which minimizes an estimated time of arrival (ETA) at the destination based on the respective positions of the vehicles in the cluster;
determine a delay in the ETA if the vehicle proceeds at a current speed, in a current lane, or at a current following distance from a vehicle directly in front of the vehicle; and
provide (i) an indication of the particular speed or the particular lane for the vehicle which minimizes the ETA, and (ii) an indication of the delay in the ETA if the vehicle proceeds at the current speed, in the current lane, or at the current following distance.

20. The computer-readable memory of claim 19, wherein the indication of the particular speed is provided for display on a client device of a user within the vehicle or a vehicle head unit.
